(19) United States
(12) Patent Application Publication
(10) Pub. No.: US 2021/0306515 A1
(43) Pub. Date: Sep. 30, 2021

(54) INFORMATION PROCESSING APPARATUS, INFORMATION PROCESSING SYSTEM, AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventor: Masashi HASEGAWA, Kanagawa (JP)

(73) Assignee: FUJIFILM Business Innovation Corp., Tokyo (JP)

(21) Appl. No.: 16/986,209

(22) Filed: Aug. 5, 2020

(30) Foreign Application Priority Data
Mar. 26, 2020 (JP) 2020-056636

(51) Int. Cl. H04N 1/327; H04N 1/00; H04N 1/32

(52) U.S. Cl. CPC H04N 1/32771; H04N 1/00938; H04N 1/32523; H04N 1/00344

(57) ABSTRACT

An information processing apparatus includes: a processor configured to derive a band for communication with a client apparatus connected to a predetermined communication network; and perform processing to control transmission of target information requested from the client apparatus back to the client apparatus, using the derived band and a priority predetermined for each of types of information to be transmitted to the client apparatus.

### CROSS-REFERENCE TO RELATED APPLICATIONS

This application is based on and claims priority under 35 USC 119 from Japanese Patent Application No. 2020-056636 filed on Mar. 26, 2020.

### BACKGROUND

### (i) Technical Field

The present disclosure relates to an information processing apparatus, an information processing system, and a non-transitory computer readable medium storing an information processing program.

### (ii) Related Art

Japanese Unexamined Patent Application Publication No. 2016-206858 proposes an image forming apparatus that includes a band estimation unit and an information division unit, and transmits a piece of information with a high priority quickly and reliably. When the image forming apparatus transmits information to a management server, the band estimation unit determines an estimated band for a network, and the information division unit selects information to be transmitted based on the estimated band, and divides the information into pieces based on a priority.

### SUMMARY

There is a case where a priority on information transmitted from an information processing apparatus, such as a server, cannot be determined by a client apparatus, and transmission of information with a low priority may cause congestion in a band of a communication network. Aspects of non-limiting embodiments of the present disclosure relate to an information processing apparatus, an information processing system, and a non-transitory computer readable medium storing an information processing program that are capable of reducing the congestion in a band of a communication network, as compared with when a client apparatus determines a priority and the information processing apparatus transmits information.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a processor configured to derive a band for communication with a client apparatus connected to a predetermined communication network; and perform processing to control transmission of target information requested from the client apparatus back to the client apparatus, using the derived band and a priority predetermined for each of types of information to be transmitted to the client apparatus.

### BRIEF DESCRIPTION OF THE DRAWINGS

Exemplary embodiment of the present disclosure will be described in detail based on the following figures, wherein:

FIG. 1 is a diagram illustrating the schematic configuration of an information processing system according to an exemplary embodiment;

FIG. 2 is a block diagram illustrating the configuration of an electrical system of an image forming apparatus according to the exemplary embodiment;

FIG. 3 is a block diagram illustrating the configuration of electrical systems of a management server A and a management server B according to the exemplary embodiment;

FIG. 4 is a functional block diagram illustrating the functional configuration of the management server B according to the exemplary embodiment;

FIG. 5 is a table illustrating an example of a transmission availability determination list;

FIG. 6 is a table illustrating an example in which a transmission availability determination list is defined for each client;

FIG. 7 is a table illustrating an example in which a transmission availability determination list is defined for each subnet;

FIG. 8 is a table illustrating an example of a subnet belonging list;

FIG. 9 is a table illustrating an example of a priority determination list;

FIG. 10 is a flowchart illustrating an example of flow of processing performed by a CPU, as a transmission availability determination unit, of the management server B in the information processing system according to the exemplary embodiment; and

FIG. 11 is a flowchart illustrating an example of flow of processing performed by a CPU, as a priority determination unit, of the management server B in the information processing system according to the exemplary embodiment.

### DETAILED DESCRIPTION

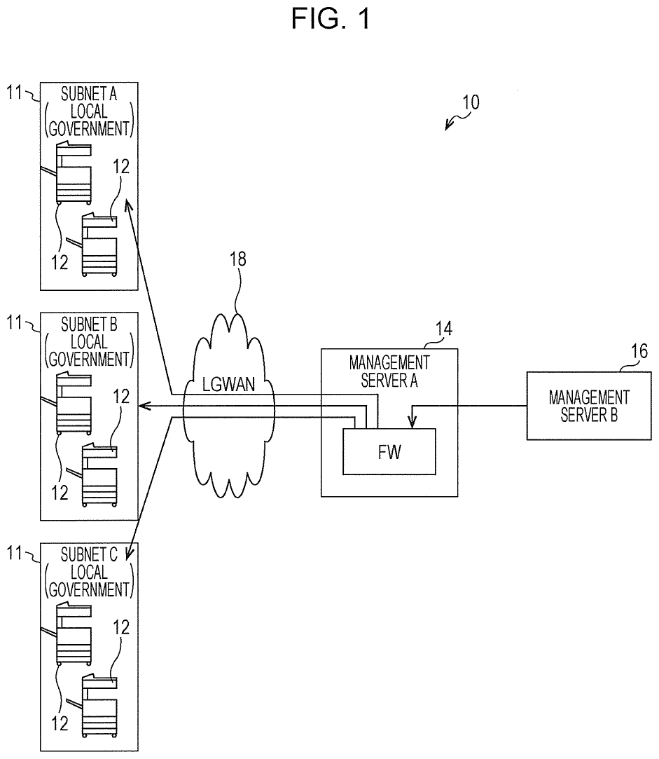

Hereinafter, an example of an exemplary embodiment of the present disclosure will be described in detail with reference to the drawings. FIG. 1 is a diagram illustrating the schematic configuration of an information processing system according to an exemplary embodiment.

As illustrated in FIG. 1, an information processing system 10 according to the exemplary embodiment includes multiple image forming apparatuses 12, a management server A14, and a management server B16 as an information processing apparatus.

The multiple image forming apparatuses 12 belong to a subnet 11 (one of subnet A, subnet B, and subnet C in FIG. 1) for each local government. Each subnet 11 is connected to a local government wide area network (LGWAN) 18 as a communication network, and the LGWAN 18 is connected to the management server A14 which is connected to the management server B16. It is to be noted that the LGWAN 18 is a network specifically for administration, which connects local governments to each other.

The management server A14 is a cloud server that provides an application service provider (ASP) service as a cloud service for a local government. In the exemplary embodiment, the management server A14 provides a service by instructions from the management server B16, the service being involved in data transfer with a relatively large volume, such as a firmware (FW) and virus patch.

In contrast, the management server B16 performs data transfer with a relatively small volume, other than the service provided by the management server A14. For instance, the management server B16 transfers data, such as a charge information, a consumables delivery notice, a failure notice, and a log notice from the image forming apparatus 12.

When the FW for the image forming apparatus 12 belonging to each subnet 11 is updated in the information processing system 10 according to an exemplary embodiment, the management server B16 uploads a target FW to the management server A14. Processing is performed such that the FW uploaded to the management server A14 is downloaded to the image forming apparatus 12 of each subnet 11 via the LGWAN 18.

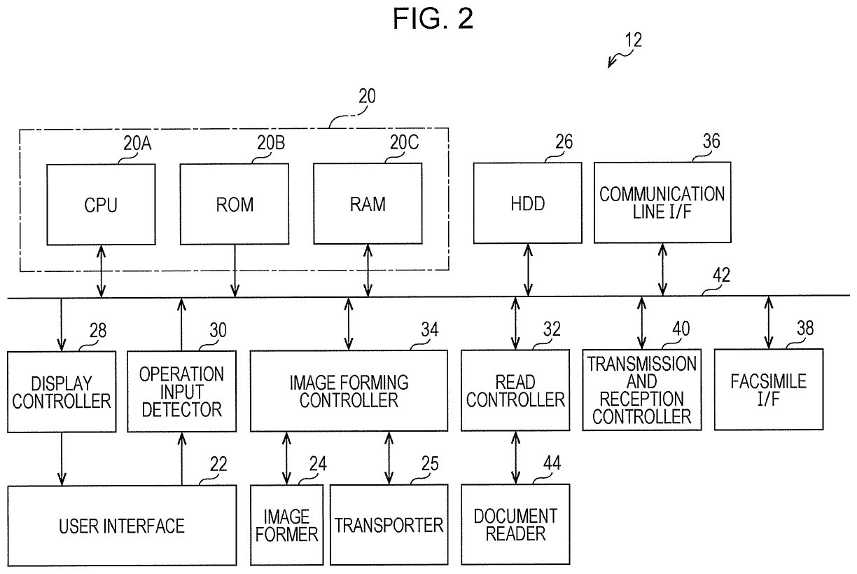

FIG. 2 is a block diagram illustrating the configuration of an electrical system of the image forming apparatus 12 according to the exemplary embodiment.

As illustrated in FIG. 2, the image forming apparatus 12 according to the exemplary embodiment includes a control unit 20 including a central processing unit (CPU) 20A, a read only memory (ROM) 20B, and a random access memory (RAM) 20C. The CPU 20A supervises the entire operation of the image forming apparatus 12. The RAM 20C is used as a work area or the like when various programs are executed by the CPU 20A. The ROM 20B pre-stores various control programs and various parameters. In the image forming apparatus 12, the components of the control unit 20 are electrically connected to each other by a system bus 42.

In addition, the image forming apparatus 12 according to the exemplary embodiment includes a hard disk drive (HDD) 26 that stores various types of data such as user information and setting parameters, and application programs. In addition, the image forming apparatus 12 includes a display controller 28 which is connected to a user interface 22 and controls the display of various operation screens on a display of the user interface 22. In addition, the image forming apparatus 12 includes an operation input detector 30 which is connected to the user interface 22 and detects an operational instruction inputted via the user interface 22. In the image forming apparatus 12, the HDD 26, the display controller 28, and the operation input detector 30 are electrically connected to the system bus 42. It is to be noted that although the HDD 26 is used as a storage in the image forming apparatus 12 according to the exemplary embodiment, without being limited to this, a non-volatile storage, such as a flash memory, may be used.

The image forming apparatus 12 according to the exemplary embodiment includes a read controller 32 that controls an optical image read operation by a document reader 44 and a document feed operation by a document feeder; and an image forming controller 34 that controls the image forming processing performed by an image former 24 and the transport of a sheet of paper to the image former 24 by a transporter 25. The image forming apparatus 12 includes a communication line interface (IF) 36 which is connected to the LGWAN 18 to transmit and receive communication data to and from the management server A14 connected to the LGWAN 18 and another external apparatus such as the management server B16. The image forming apparatus 12 includes a facsimile interface (IF) 38 which is connected to a phone line (not illustrated) and transmits and receives facsimile data to and from a facsimile device connected to the phone line. In addition, the image forming apparatus 12 includes a transmission and reception controller 40 that controls the transmission and reception of facsimile data via the facsimile IF 38. In the image forming apparatus 12, the transmission and reception controller 40, the read controller 32, the image forming controller 34, the communication line IF 36, and the facsimile IF 38 are electrically connected to the system bus 42.

With the configuration described above, the image forming apparatus 12 according to the exemplary embodiment makes access to each of the RAM 20C, the ROM 20B, and the HDD 26 by the CPU 20A. The image forming apparatus 12 controls the display of an operation screen on a display of the interface 22 and of information such as various messages by the CPU 20A. The image forming apparatus 12 controls the operation of the document reader 44 and a document transporter via the read controller 32 by the CPU 20A. In addition, the image forming apparatus 12 controls the operation of the image former 24 and the transporter 25 via the image forming controller 34 and controls the transmission and reception of communication data via the communication line IF 36 by the CPU 20A. The image forming apparatus 12 controls the transmission and reception of facsimile data via the facsimile IF 38 by the transmission and reception controller 40. In addition, the image forming apparatus 12 recognizes an operational detail of the user interface 22 based on the operation information detected by the operation input detector 30, and performs various control based on the operational detail.

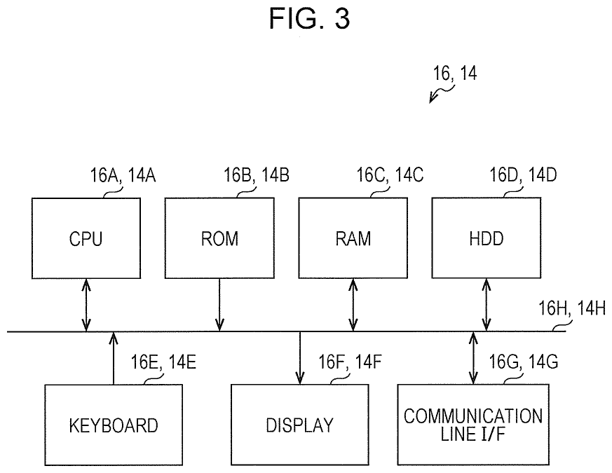

Subsequently, the configuration of the electrical systems of the management server A14 and the management server B16 according to the exemplary embodiment will be described. FIG. 3 is a block diagram illustrating the configuration of the electrical systems of the management server A14 and the management server B16 according to the exemplary embodiment. The management server A14 and the management server B16 basically provide the configuration of a general computer, thus the management server B16 will be described herein as a representative configuration.

As illustrated in FIG. 3, the management server B16 according to the exemplary embodiment includes a CPU 16A, a ROM 16B, a RAM 16C, a HDD 16D, a keyboard 16E, a display 16F, and a communication interface (IF) 16G. The CPU 16A supervises the entire operation of the management server B16. The ROM 16B pre-stores various control programs and various parameters. The RAM 16C is used as a work area or the like when various programs are executed by the CPU 16A. The HDD 16D stores various types of data and application programs. The keyboard 16E is used to input various types of information. The display 16F is used to display various types of information. The communication IF 16G is connected via the management server A14 to the LGWAN 18 to transmit and receive various types of data to and from another apparatus connected to the LGWAN 18. The components of the aforementioned management server B16 are electrically connected to each other by a system bus 16H. It is to be noted that although the HDD 16D is used as a storage in the management server B16 according to the exemplary embodiment, without being limited to this, another non-volatile storage, such as a flash memory, may be used.

With the configuration described above, the management server B16 according to the exemplary embodiment performs access to the ROM 16B, the RAM 16C, and the HDD 16D; acquisition of various type of data via the keyboard 16E; and display of various types of information on the display 16F by the CPU 16A. In addition, the management server B16 controls the transmission and reception of communication data via the communication line IF 16G by the CPU 16A.

In the exemplary embodiment, the CPU 16A drives a band for communication with the image forming apparatus 12 connected to the LGWAN 18, and performs processing to control the transmission of target information to the image forming apparatus 12 using the derived band and a priority predetermined for each type of information to be transmitted to the image forming apparatus 12, the target information being requested from the image forming apparatus 12.

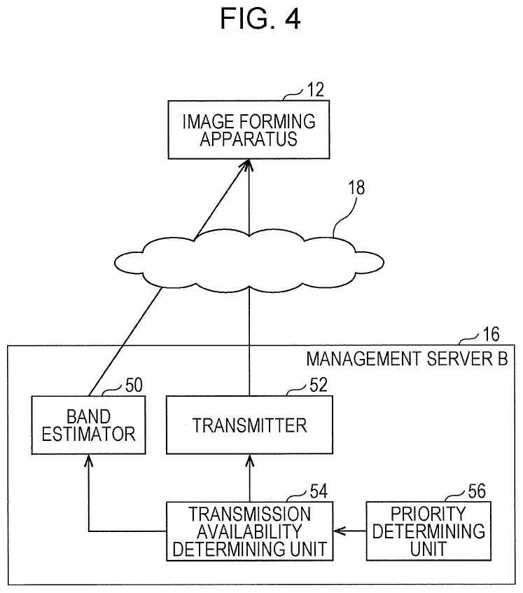

Next, the functional configuration of the management server B16 in the information processing system 10 according to the exemplary embodiment will be described. FIG. 4 is a functional block diagram illustrating the functional configuration of the management server B16 according to the exemplary embodiment.

As illustrated in the FIG. 4, the management server B16 has the functions of a band estimator 50, a transmitter 52, a transmission availability determining unit 54, and a priority determining unit 56. It is to be noted that each functional unit is implemented by the CPU 16A executing a program stored in the ROM 16B or the HDD 16D.

When data having a relatively large volume such as a FW or virus patch is transmitted to the image forming apparatus 12, the band estimator 50 estimates the situation of available band between the image forming apparatus 12 and the management server A14. When data having a relatively small volume, other than a FW or virus patch is transmitted, the band estimator 50 estimates the band between the image forming apparatus 12 and the management server B16. Estimation of the band is made by a well-known technique. For instance, the band may be measured by sending a signal, or may be estimated using the statistics of the band according to time in the past.

When the transmission availability determining unit 54 determines that “transmission is possible”, the transmitter 52 transmits data to the image forming apparatus 12.

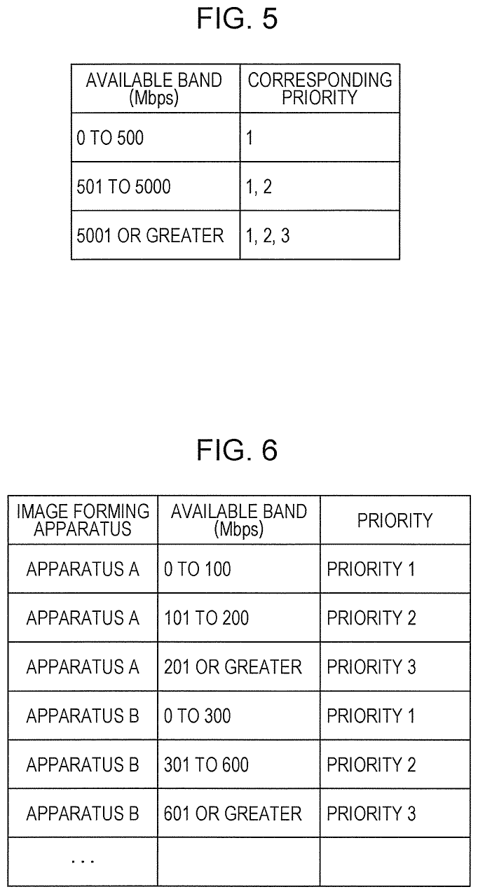

The transmission availability determining unit 54 determines based on the information from the priority determining unit 56 and the band estimator 50 whether or not an operation request from the image forming apparatus 12 is executed. Whether or not an operation request from the image forming apparatus 12 is executed is determined, for instance, by using a transmission availability determination list illustrated in FIG. 5. In the example of the transmission availability determination list illustrated in FIG. 5, when an available band is in 0 to 500 Mbps, an operation request with a priority of 1 is executed. Also, when an available band is in 501 to 5000 Mbps, an operation request with a priority of 1 or 2 is executed. When an available band is greater than or equal to 5001 Mbps or, an operation request with a priority of 1, 2 or 3 is executed.

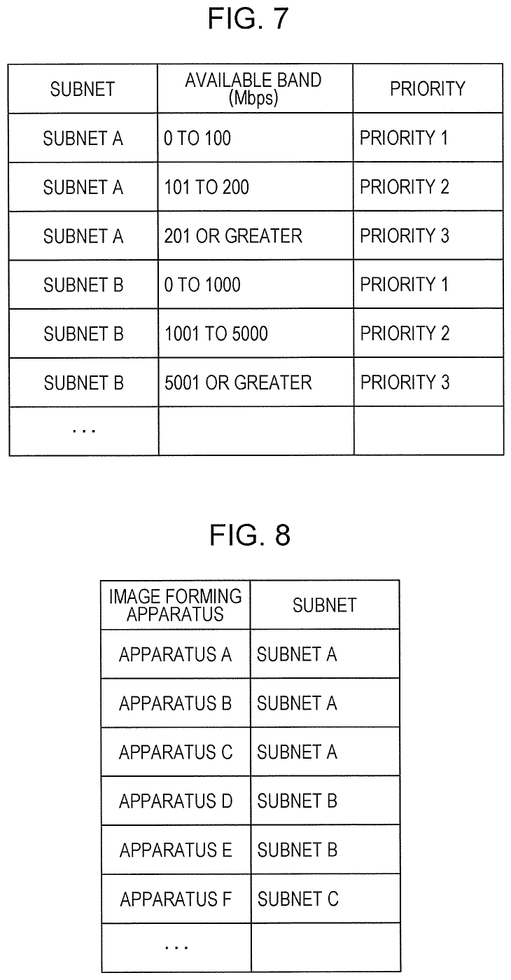

It is to be noted that the relationship between an available band and a feasible operation varies depending on each client, and even with the same available band, whether or not a specific operation is available varies according to the band of a network and the number of apparatuses connected. The list illustrated in FIG. 6 or FIG. 7 may be used as the transmission availability determination list.

The example of the transmission availability determination list illustrated in FIG. 6 defines a transmission availability determination list for each client. Unlike the transmission availability determination list illustrated in FIG. 6, which is common to all clients, a table is created for each client. In the example of FIG. 6, in an apparatus A, when an available band is in 0 to 100 Mbps, an operation request with a priority of 1 is executed, when an available band is in 101 to 200 Mbps, an operation request with a priority of 2 is executed, and when an available band is greater than or equal to 201 Mbps, an operation request with a priority of 3 is executed. In addition, in an apparatus B, when an available band is in 0 to 300 Mbps, an operation request with a priority of 1 is executed, when an available band is in 301 to 600 Mbps, an operation request with a priority of 2 is executed, and when an available band is greater than or equal to 601 Mbps, an operation request with a priority of 3 is executed.

In contrast, the example of the transmission availability determination list illustrated in FIG. 7 defines a transmission availability determination list for each subnet 11. In the actual network structure, the image forming apparatuses 12 in the subnet 11 of each of the subnets A to C illustrated in FIG. 1 have the same estimated band, thus the band does not need to be estimated for all of the image forming apparatuses 12 in the same subnet 11. In other words, it is sufficient that the network band be measured for each subnet 11, and the subnet 11 to which corresponding image forming apparatuses 12 belong be managed. It is to be noted that as the band for communication with the subnet 11, for instance, a band for communication with a predetermined image forming apparatus 12 or information processing terminal in the subnet 11 may be measured. Alternatively, the average value of the bands for communication with multiple apparatuses in the subnet 11 may be measured as the band for communication with the subnet 11. In the example of FIG. 7, in the subnet A, when an available band is in 0 to 100 Mbps, an operation request with a priority of 1 is executed, when an available band is in 101 to 200 Mbps, an operation request with a priority of 2 is executed, and when an available band is greater than or equal to 201 Mbps, an operation request with a priority of 3 is executed. In the subnet B, when an available band is in 0 to 1000 Mbps, an operation request with a priority of 1 is executed, when an available band is in 1001 to 5000 Mbps, an operation request with a priority of 2 is executed, and when an available band is greater than or equal to 5001 Mbps, an operation request with a priority of 3 is executed. As in the subnet belonging table illustrated in FIG. 8, apparatuses A to C belong to the subnet A, and apparatuses D, E belong to the subnet B, and an apparatus F belongs to the subnet C.

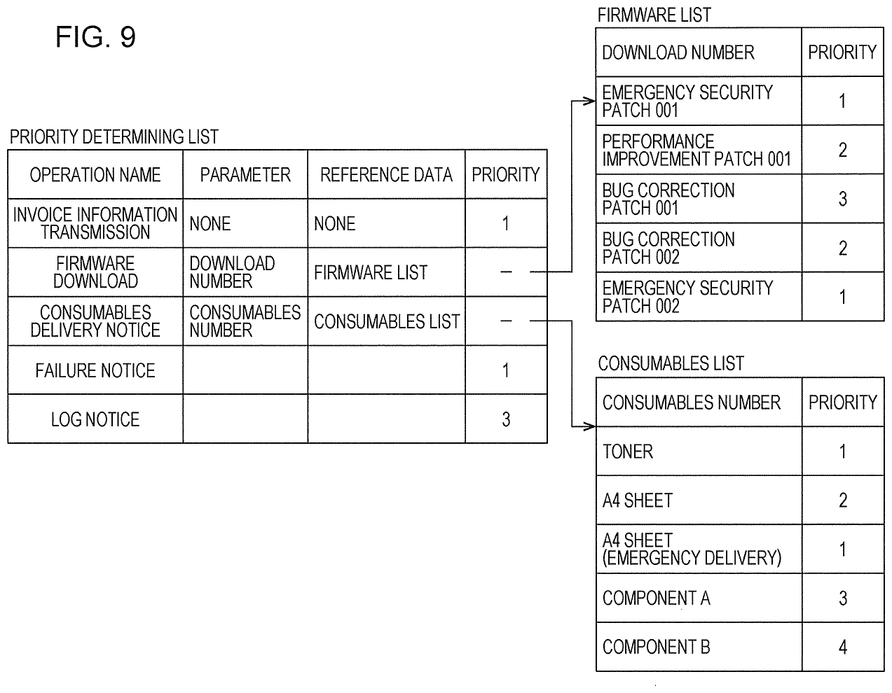

For an operation request from the image forming apparatus 12, the priority determining unit 56 assigns a priority to determine whether accepting the request for each operation content. For instance, a priority is assigned using the priority determination list illustrated in FIG. 9. In the priority determination list illustrated in FIG. 9, an operation name, a parameter, reference data, and a priority are defined. For the operation names of firmware download and consumables delivery notice, a firmware list and a consumables list are separately provided, and a priority is defined for each content of the list.

Subsequently, specific processing performed by the management server B16 in the information processing system 10 according to the exemplary embodiment thus configured will be described.

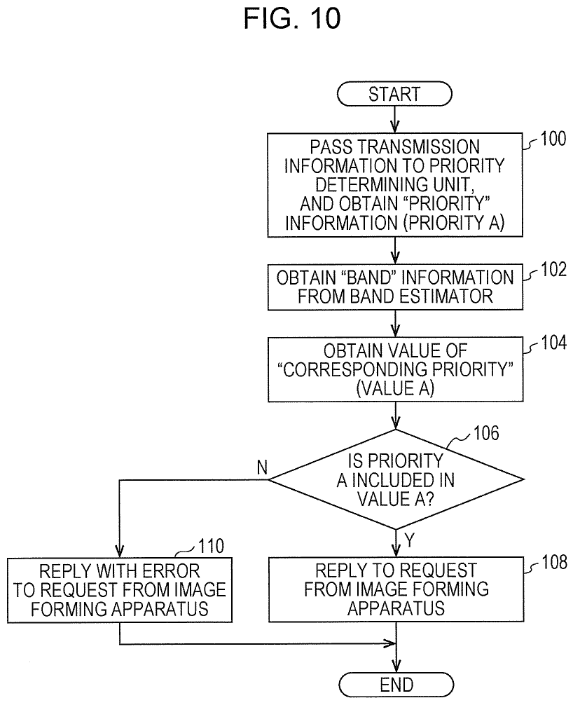

First, specific processing performed by the CPU 16A, as the transmission availability determining unit 54, of the management server B16 will be described. FIG. 10 is a flowchart illustrating an example of flow of processing performed by the CPU 16A, as the transmission availability determination unit, of the management server B16 in the information processing system 10 according to the exemplary embodiment. It is to be noted that the processing of FIG. 10 is started when the management server B16 receives an operation request from the image forming apparatus 12.

In step 100, the CPU 16A passes transmission information to the priority determining unit 56, and obtains “priority” information (priority A), then the flow proceeds to step 102. In other words, the transmission information received as an operation request from the image forming apparatus 12 is passed to the priority determining unit 56, and the priority A is obtained as a result of determination of a priority.

In step 102, the CPU 16A obtains information on “band” from the band estimator 50, and the flow proceeds to step 104.

In step 104, the CPU 16A obtains the value A of a corresponding priority corresponding to the band in the transmission availability determination list, and the flow proceeds to step 106.

In step 106, the CPU 16A determines whether the priority A is included in the value A. When positive determination is made, the flow proceeds to step 108, and when negative determination is made, the flow proceeds to step 110.

In step 108, the CPU 16A replies to the request from the image forming apparatus 12, and completes a series of processing. Specifically, the transmitter 52 performs processing to transmit information to the image forming apparatus 12, the information corresponding to an operation requested from the image forming apparatus 12.

In contrast, in step 110, the transmitter 52 of the CPU 16A replies with an error to the request from the image forming apparatus 12, and completes a series of processing.

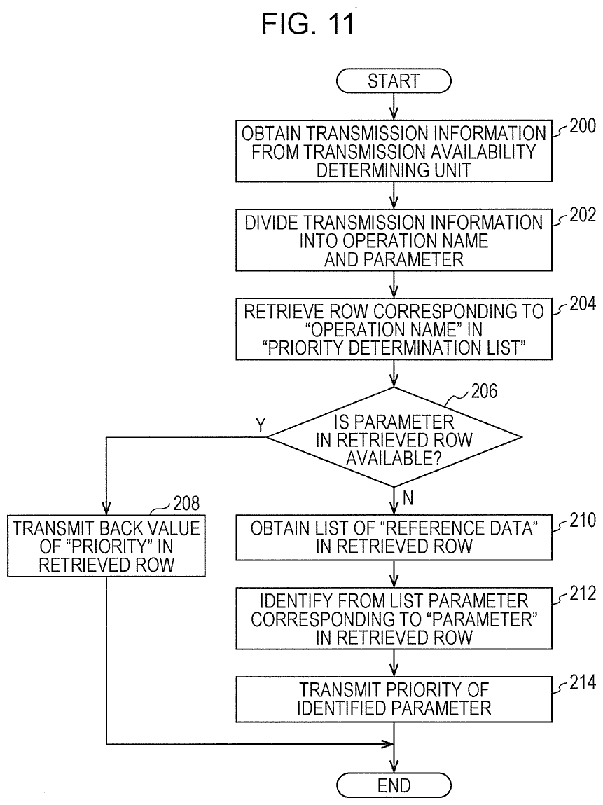

Next, specific processing performed by the CPU 16A, as the priority determining unit 56, of the management server B16 will be described. FIG. 11 is a flowchart illustrating an example of flow of processing performed by the CPU 16A, as the priority determination unit, of the management server B16 in the information processing system 10 according to the exemplary embodiment. It is to be noted that the processing of FIG. 11 is started when the processing in step 100 described above is performed.

In step 200, the CPU 16A obtains transmission information from the transmission availability determining unit 54, and the flow proceeds to step 202.

In step 202, the CPU 16A divides the transmission information into an operation name and a parameter, and the flow proceeds to step 204.

In step 204, the CPU 16A retrieves a row corresponding to the “operation name” in the “priority determination list”, and the flow proceeds to step 206.

In step 206, the CPU 16A determines whether the parameter of the retrieved a row is available. When positive determination is made, the flow proceeds to step 208, and when negative determination is made, the flow proceeds to step 210.

In step 208, the CPU 16A transmits back the value of the “priority” in the retrieved row as the priority A, and completes a series of processing.

In contrast, in step 210, the CPU 16A obtains the list of the “reference data” in the retrieved row, the flow proceeds to step 212. For instance, the CPU 16A obtains a corresponding list from the firmware list and the consumables list included in the priority determination list of FIG. 9.

In step 212, from the obtained list, the CPU 16A identifies the parameter corresponding to the “parameter” in the retrieved row, and flow proceeds to step 214.

In step 214, the CPU 16A transmits back the priority of the identified parameter as the priority A, and completes a series of processing.

In the exemplary embodiment, the image forming apparatus 12 has been described to include the management server A14 and the management server B16. However this is not always the case. For instance, the management server A14 and the management server B16 may form a single management server. Alternatively, multiple management servers other than the management server A14 may be provided for each type of information transmitted back to the image forming apparatus 12.

In addition, in the exemplary embodiment, an example has been described, in which the management server B16 has the functions of the band estimator 50, the transmitter 52, the transmission availability determining unit 54, and the priority determining unit 56. However this is not always the case. For instance, the management server A14 or another server may have at least one of those functions.

In the exemplary embodiment above, the CPU has been described as an example of a processor, and the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The processing performed by the management server B16 according to the exemplary embodiment may be performed by software, may be performed by hardware, or may be performed by a combination of software and hardware. In addition, the processing performed by management server B16 may be stored in a recording medium as a program, and distributed.

The present disclosure is not limited to the above described, and in addition to the above described, the present disclosure may be modified in various ways and implemented within a range not departing from the spirit of the present disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising a processor configured to
derive a band for communication with a client apparatus connected to a predetermined communication network; and
perform processing to control transmission of target information requested from the client apparatus back to the client apparatus, using the derived band and a priority predetermined for each of types of information to be transmitted to the client apparatus.

2. The information processing apparatus according to claim 1, wherein as the band for communication with the client apparatus, the processor derives a band for communication with a subnet to which the client apparatus is connected.

3. The information processing apparatus according to claim 2, wherein as the band for communication with the subnet, the processor derives a band for communication with a predetermined apparatus in the subnet.

4. The information processing apparatus according to claim 1, wherein the processor obtains a band for the client apparatus from an apparatus in which the target information is stored.

5. The information processing apparatus according to claim 2, wherein the processor obtains a band for the client apparatus from an apparatus in which the target information is stored.

6. The information processing apparatus according to claim 3, wherein the processor obtains a band for the client apparatus from an apparatus in which the target information is stored.

7. The information processing apparatus according to claim 4, wherein when a predetermined type of information is stored as the target information in a first apparatus different from the information processing apparatus and the predetermined type of information is transmitted, the processor derives a band for the client apparatus from the first apparatus.

8. The information processing apparatus according to claim 5, wherein when a predetermined type of information is stored as the target information in a first apparatus different from the information processing apparatus and the predetermined type of information is transmitted, the processor derives a band for the client apparatus from the first apparatus.

9. The information processing apparatus according to claim 6, wherein when a predetermined type of information is stored as the target information in a first apparatus different from the information processing apparatus and the predetermined type of information is transmitted, the processor derives a band for the client apparatus from the first apparatus.

10. The information processing apparatus according to claim 7, wherein when information other than the predetermined type of information is stored as the target information in the information processing apparatus and the information other than the predetermined type of information is transmitted, the processor derives a band for the client apparatus from the information processing apparatus.

11. The information processing apparatus according to claim 8, wherein when information other than the predetermined type of information is stored as the target information in the information processing apparatus and the information other than the predetermined type of information is transmitted, the processor derives a band for the client apparatus from the information processing apparatus.

12. The information processing apparatus according to claim 9, wherein when information other than the predetermined type of information is stored as the target information in the information processing apparatus and the information other than the predetermined type of information is transmitted, the processor derives a band for the client apparatus from the information processing apparatus.

13. The information processing apparatus according to claim 7, wherein the predetermined type of information is a firmware of the client apparatus.

14. The information processing apparatus according to claim 8, wherein the predetermined type of information is a firmware of the client apparatus.

15. The information processing apparatus according to claim 9, wherein the predetermined type of information is a firmware of the client apparatus.

16. The information processing apparatus according to claim 10, wherein the predetermined type of information is a firmware of the client apparatus.

17. The information processing apparatus according to claim 11, wherein the predetermined type of information is a firmware of the client apparatus.

18. The information processing apparatus according to claim 12, wherein the predetermined type of information is a firmware of the client apparatus.

19. An information processing system comprising:
a client apparatus connected to a predetermined communication network; and
the information processing apparatus according to claim 1.

20. A non-transitory computer readable medium storing an information processing program causing a computer to execute a process comprising:
deriving a band for communication with a client apparatus connected to a predetermined communication network; and
performing processing to control transmission of target information requested from the client apparatus back to the client apparatus, using the derived band and a priority predetermined for each of types of information to be transmitted to the client apparatus.
